(19) United States
(12) Patent Application Publication
(10) Pub. No.: US 2014/0244336 A1
(43) Pub. Date: Aug. 28, 2014

(54) APPOINTMENT SCHEDULER AND LOCATION TRACKER

(71) Applicant: Darren Braunstein, Warren, NJ (US)

(72) Inventor: Darren Braunstein, Warren, NJ (US)

(21) Appl. No.: 13/826,045

(22) Filed: Mar. 14, 2013

Related U.S. Application Data
(60) Provisional application No. 61/770,869, filed on Feb. 28, 2013.

(51) Int. Cl. G06Q 10/10

(52) U.S. Cl. CPC G06Q 10/1095
USPC 705/7.19

(57) ABSTRACT

The invention is directed to scheduling appointments for a field representative and tracking locations of the field representative. New or updated scheduling information regarding appointments to be carried out by the field representative at specified locations is received at a host device from an admin terminal and is stored. Location information about the field representative is entered into a first remote device each time that the field representative arrives at or departs from one of the specified locations and is sent over the network to the host device. The current location of the field representative is updated at the host device each time that the location information about the field representative is received. The current location of and an estimated arrival time of the field representative at a particular one of the specified locations are provided from the host device over the network to a second remote device.

### CROSS-REFERENCE TO RELATED APPLICATIONS

The present application claims the benefit of the filing date of U.S. Provisional Patent Application No. 61/770,869, filed Feb. 28, 2013, the disclosure of which is hereby incorporated herein by reference.

### BACKGROUND OF THE INVENTION

The present invention is directed to tracking the movement of field representatives between and during service calls and to enabling a customer who is scheduled to receive a service call to follow the movement of the field representative that is to make the service call.

### BRIEF SUMMARY OF THE INVENTION

According to an aspect of the invention, a host device is connected to a network and is operable to schedule appointments for a field representative and to track locations of the field representative. A processor is encoded with instructions for processing and storing new or updated scheduling information provided to the host device regarding appointments to be carried out by the field representative at specified locations. Location information about the field representative is processed which is entered into a first remote device each time that the field representative arrives at or departs from one of the specified locations and sent over the network to the host device. A current location of the field representative is updated each time that the location information about the field representative is received. The current location of the field representative and an estimated arrival time of the field representative at a particular one of the specified locations are provided over the network to a second remote device.

In accordance with this aspect of the invention, an appointment scheduler and location tracker system includes the host device, a portable device operable as the first remote device, and a personal computer or portable device operable as the second remote device.

Another aspect of the invention is a method of scheduling appointments for a field representative and tracking locations of the field representative.

A further aspect of the invention is a non- transitory computer-readable medium having recorded therein a computer program for carrying out a method of scheduling appointments for a field representative and tracking locations of the field representative.

### BRIEF DESCRIPTION OF THE DRAWINGS

FIG. 1 is a block diagram illustrating an example of a system for carrying out the present invention.

FIG. 2 is a flowchart depicting the steps carried out in conjunction with the entry of information for scheduled service calls in accordance with the invention.

FIG. 3 is a diagram showing an example of an admin screen of the invention.

FIG. 4 is a flowchart depicting the steps carried out to display and update a field representative tracking screen in accordance with the invention.

FIG. 5 is a diagram showing an example of a field representative tracking screen according to the invention.

FIG. 6 is a flowchart illustrating the steps carried out to access and display a dashboard screen according to the invention.

FIG. 7 is a diagram showing an example of a dashboard screen of the invention.

FIG. 8 is a flowchart depicting the steps carried out to access a customer view screen according the invention.

FIGS. 9A and 9B are diagrams illustrating examples of customer view screens of the invention.

FIG. 10 is a diagram illustrating an example of a text message received by a customer cellphone according to the invention.

### DETAILED DESCRIPTION

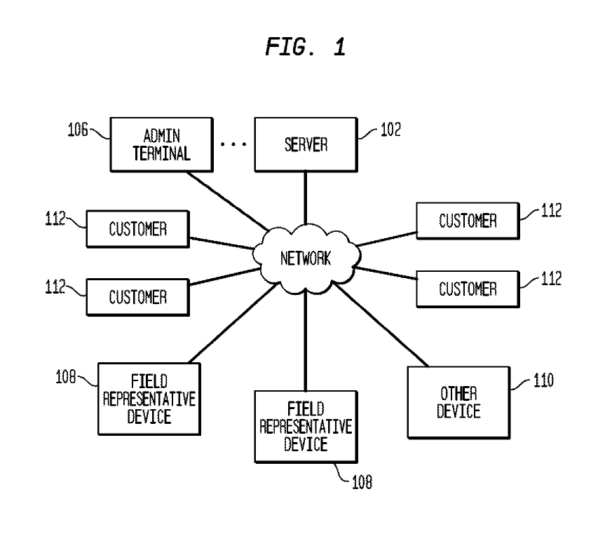

FIG. 1 illustrates an example of an appointment scheduler and location tracker system 100 in accordance with an embodiment of the invention. A server 102 operates as a host for the system and is connected to a network 104, such as the Internet or other network. The server runs the application software and other software needed to carry out the invention and stores the various display screens of the invention. Such software resides at least in one or more processors (not shown) of the server at least while carrying out the invention. Preferably the application software and other software is also stored in a recording medium, such as a memory device or disk (not shown), which may reside within the server or be connected thereto. Additionally, data necessary for carrying out the invention, such as customer information and order numbers, field representative identification numbers and other field representative information, and scheduling and tracking data may be stored within the server 102, such as in a database, or such date may be stored in an adjunct device connected to the server.

An admin terminal 106 communicates with the server 102 over the network 104. Alternatively, the administrative terminal may be connected directly to or via a local area network to the server. The admin terminal is used, for example, to display an admin screen in which the schedules of service visits for various field representatives are entered in advance, such as the day before such visits are to be carried out. A field representative device 108, such as a smart phone or other portable device, communicates over the network 104 with the server 102 and is used by a field representative to view the representative's schedule for that day and to update the field representative's current location, such as at a start of a service visit and at an end of a service visit.

Other devices 110 may also communicate with the server 102, such as by an authorized representative, to access a dashboard screen showing the current location of field representatives and information relating to the service visits carried out by each representative. The device 110 used by the authorized representative may be, for example, a desktop computer, a laptop or notebook computer, a smartphone, or other portable device.

Customer devices 112 are also connected over the network to the server 102 to enable a customer to view the scheduled or estimated arrival time of the field representative scheduled to carry out a service call for that customer and to view the current location of that field representative. The customer device may be, for example, a desktop computer, a laptop or notebook computer, a smartphone, or other portable device.

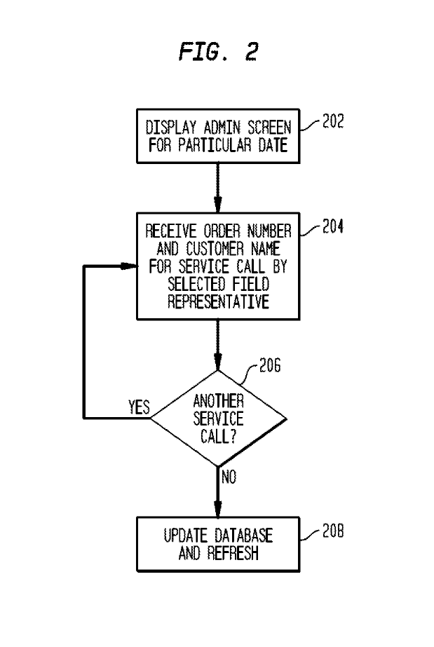

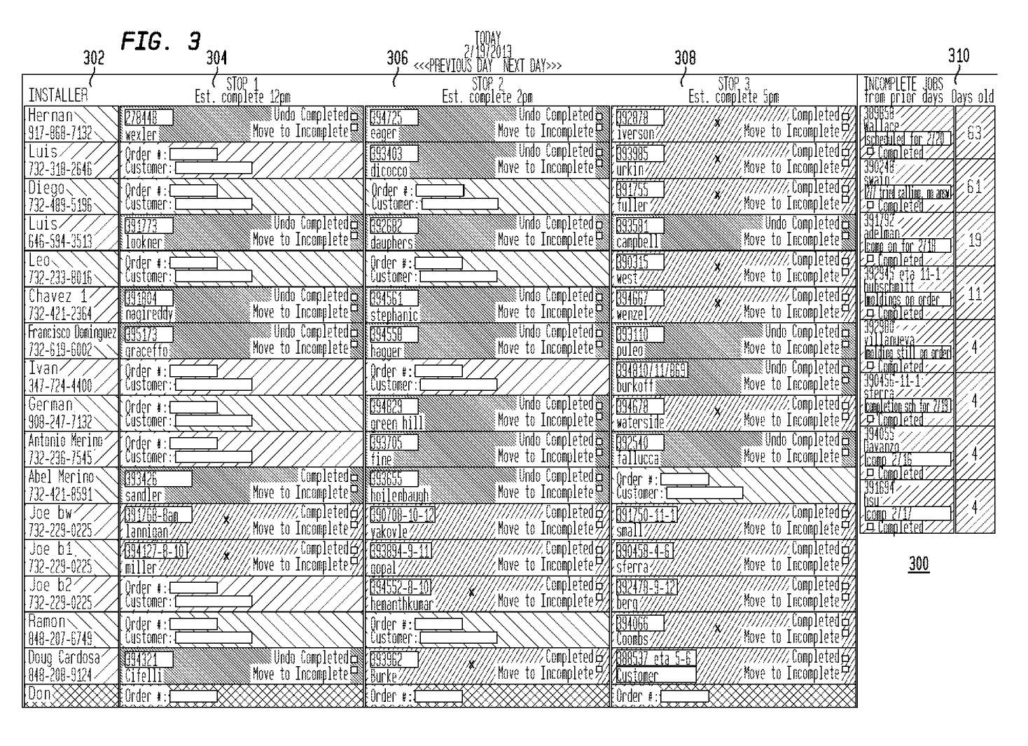

FIG. 2 illustrates an example of the steps carried out while an administrator enters and/or updates schedule of a service calls for the field representatives, in accordance with the invention. As step 202 shows, the server 102 displays one or more web pages, such as the admin screen 300 shown in FIG. 3, by which the service call schedule for a given day is entered using the admin terminal 106. Prior to displaying such web pages, the server 102 may require authentication of the administrator, such as by requesting entry of an ID number or other identification of the administrator and, preferably, a password, at the time that the admin terminal 106 is first connected to the server 102 over the network 104. Alternatively, when the admin terminal 106 is connected directly to the server or is connected over a local area network to the server, such authentication may be omitted.

FIG. 3 illustrates an example of an admin screen 300 provided by the server 102 for display by the admin terminal 106. The admin screen includes column 302 having fields which identify the respective field representatives, such as by name and telephone number. Columns 304, 306, and 308 each include fields which identify the service calls scheduled for each field representative for a particular day. Though only three columns are shown, additional columns or fewer columns may be depicted to allow for the scheduling of a greater number or smaller number of service calls per day. Each service call field includes information concerning a particular service call, such as a customer order number and customer name. Additionally, column 310 lists the uncompleted service calls from prior days and shows, for example, the order number, customer name, and scheduled date of the uncompleted service call as well as the number of days that have passed since the scheduled date.

To schedule a service call by a selected field representative to a particular customer, service call information, such as an order number and customer name, are entered by the administrator into one of the fields of column 304, 306, or 308 and is received by the server 102, as shown in step 204. The column chosen depends on whether the service call is to be the first service call, second service call, or third service call of the day for that representative.

When the administrator is to schedule another service call for that representative, as step 206 shows, the information relating to the further service call is entered into the admin screen and is received by the server, namely, step 204 is repeated. Similarly, when information relating to the service calls of other field representatives is entered, that step 204 repeated for each entry.

Alternatively, when no further service call information is entered into the admin screen within a specific interval, such as for 30 or 60 seconds, the server updates the database containing the service call information and/or refreshes the screen, as step 208 shows. The database is updated and/or the screen refreshed at the end of each interval regardless of whether new data has been entered during that interval.

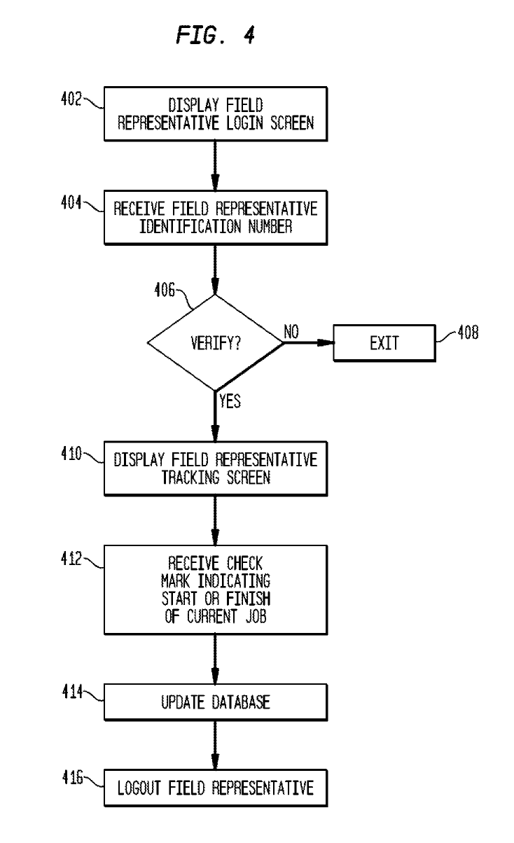

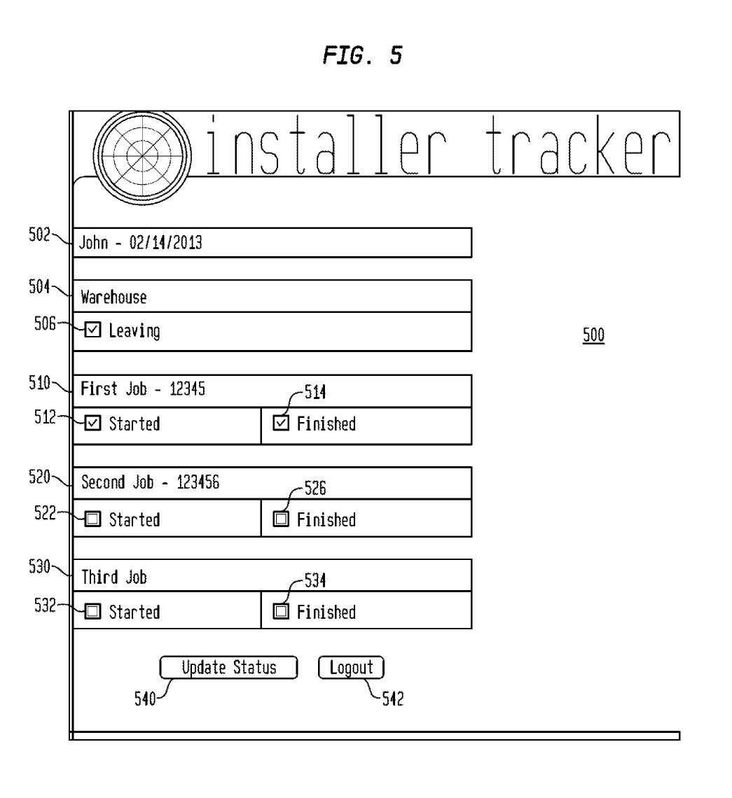

FIG. 4 illustrates the steps carried out in accordance with the invention when a field representative views and/or updates the field representative's service call schedule for that day. First, the field representative initiates a connection between the representative's device 108 and the server 102 over the network 104 using, for example, a browser or an application (“app”) stored in the smartphone or other portable device of the representative. In response, the server 102 causes the field representative's device to display a login screen, as step 402 shows. The field representative then enters the representative's identification number and/or other identification information in the appropriate fields of the login screen, and the entered information is received by the server 102, as step 404 shows. The server then verifies the entered identification number or other identification information, as shown in step 406. When the server successfully verifies the entered information as corresponding to a particular field representative, the server causes a web page to be displayed on the field representative's device, as shown at step 410. For example, the web page displayed is the field representative tracking screen 500 shown in FIG. 5. Alternatively, when the server is unable to verify the entered identification number or other information, the server denies access and exits, as step 408 shows.

FIG. 5 depicts an example of the field representative tracking screen 500 of the invention. The tracking screen 500 includes field 502 that shows information identifying the representative, such as a name, and may include the current date. Also displayed are field 504 showing the field representative's starting location that day, such as at a warehouse, and fields 510, 520, and 530 showing the scheduled service calls, respectively. Additional information for each service call may be displayed in the fields 510, 520, and 530, such as the order numbers of the service calls. The tracking screen 500 also includes various checkboxes, or other types of information entry icons or fields, by which the service representative indicates arrival at or departure from a particular service call or other location. For example, the field representative checks off box 506 upon leaving a warehouse or other starting location that day. The entry in the box 506 is received by the server 102, as shown at step 412 of FIG. 4. Then, the field representative clicks on or touches the Update Status field 540, and the server 102 then updates the database by recording the corresponding location as the current location of the field representative. The server 102 also records a time of day, such as a time at which the box is checked or a time at which the Update Status field is clicked. The field representative then clicks on or touches the Logout field 542 to log out from the server, as step 416 shows.

Subsequently, when the field representative arrives at the first service call location, the field representative again logs in as described above, and the server 102 displays the field representative tracking screen 500 now showing the previously checked box 506. The field representative then checks box 512 indicating arrival at the first service call location, and the clicks on or touches the Update Status field 540 and the Logout field 542 by which the server 102 repeats the steps described above.

When the field representative completes the first service call and is about to leave the service call location, the service representative again logs in according to the above-described manner, and the server displays the field representative tracking screen now showing both boxes 506 and 512 as being previously checked. The field representative then checks box 514 and next clicks on or touches the Update Status and Logout icons. The server 112 then carries out the steps described above.

The field representative repeats the above operations whenever the field representative arrives at or departs from each of the succeeding service calls. That is, the service representative checks the appropriate box from among boxes 522, 524, 532, 534, etc., and next clicks on or touches the Update Status and Logout icons, during which the server 102 repeats the above-described steps.

Each time that the service representative carries out these operations, the current location of the service representative is changed. That is, during the course of a day, the current location of the service representative is initially the warehouse or other staring location, and then changes from the starting location to being in transit from the starting location to the first service call, from being in transit to being located at the first service call, from being located at the first service call to being in transit from the first service call to the second service call, and so forth.

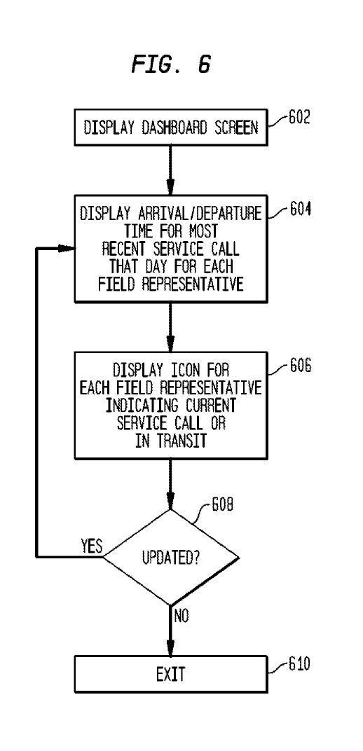

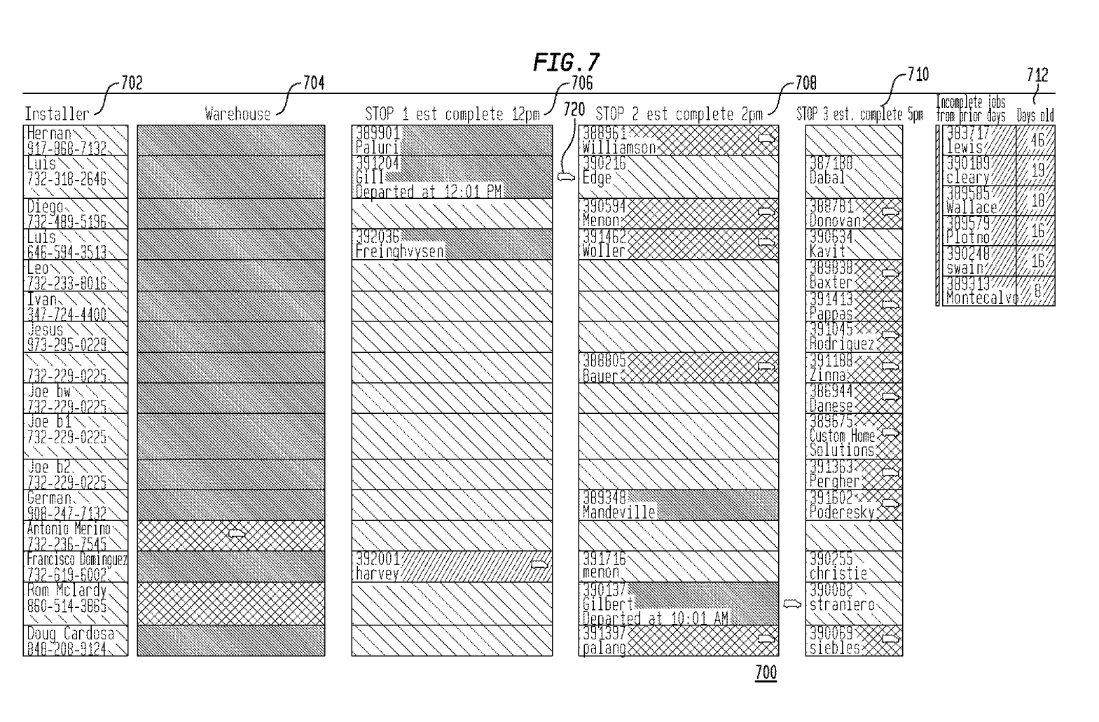

FIG. 6 is a diagram illustrating the steps carried out in accordance with the invention when an authorized representative or other permitted individual seeks to view a web page providing the current location of each field representative, such as using the dashboard screen 700 shown in FIG. 7. As step 602 shows, the server 102 accesses and displays such a dashboard screen and displays the current location and other service call information for each field representative, as shown in step 602.

FIG. 7 shows an example of a dashboard screen 700. Column 702 shows respective fields which identify each service representative, such as by name and telephone number. Column 704 shows respective fields corresponding each service representatives' starting location. Columns 706, 708, and 710 show respective fields corresponding to the service calls for each field representative. Additionally, column 712 includes information relating to the uncompleted service calls of prior days and may have a format similar to that displayed in column 310 of FIG. 3.

Prior to the server displaying the dashboard screen, such as after the authorized representative connects to the server using device 110 over the network 104, login and authorization may be carried out by the server similar to that previously described. Alternatively, such authentication may be omitted when the device 110 is connected directly to the server or is connected over a local area network to the server.

As part of the display of the dashboard screen, the server displays information identifying each service call in its respective field, such as the order number and customer name, and causes an arrival or departure time to be displayed in the field corresponding to the most recent service call of each field representative, as shown in step 604 of FIG. 6. Additionally, the server causes an icon 720 to be displayed whose location indicates that a field representative is currently at a particular service call location or is in transit between service call locations, as shown in step 606. Alternatively, changes in the color and/or shape of the icon indicates that the field representative is currently at a particular service call location or is in transit.

The server also causes the dashboard screen 700 to be updated at specific intervals, as step 608 shows. At each update, step 604 and 606 are repeated so that the most recent departure or arrival time of the service calls and the current location of each representative are updated. The specific intervals between each update may be preset intervals, such as every 30 or 60 seconds, or may be intervals determined based on the current load on the server. The dashboard screen may also be updated whenever a service representative checks in or checks out of a service call.

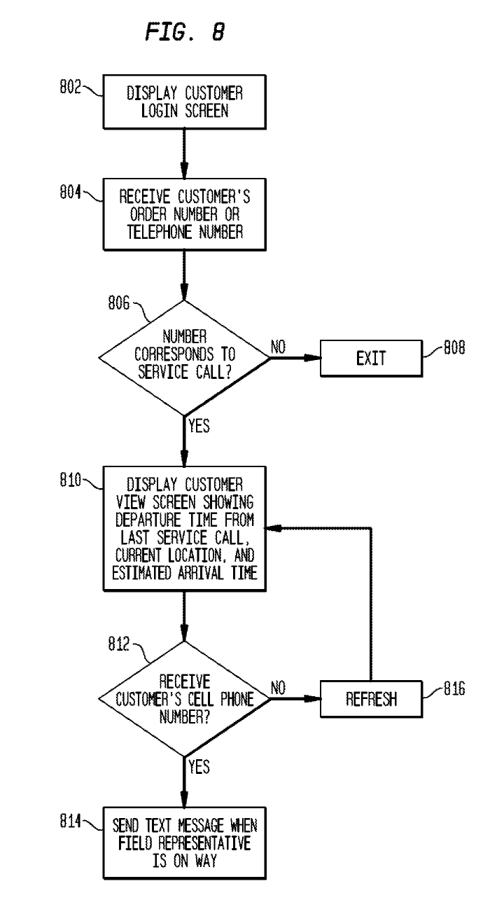

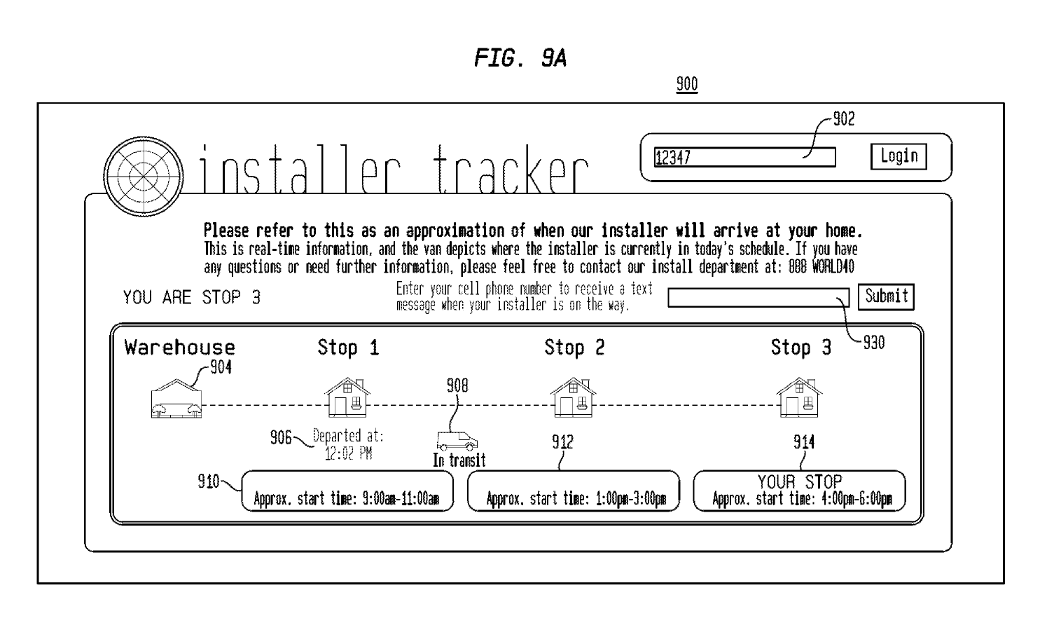

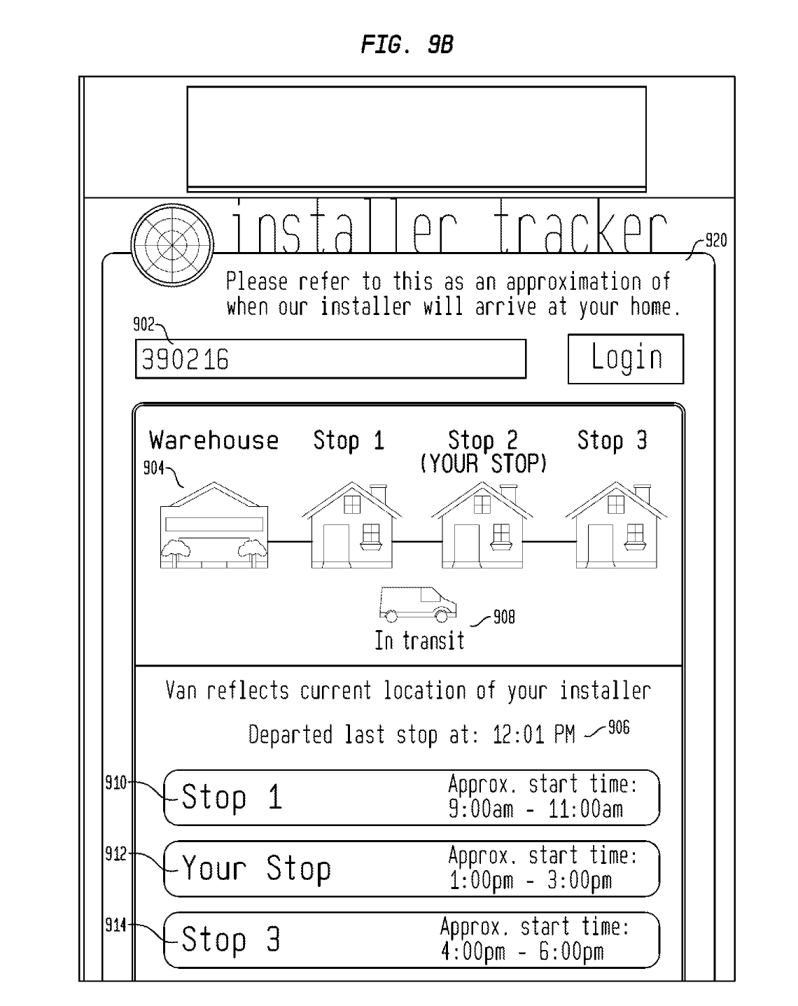

FIG. 8 illustrates an example of the steps carried out when a customer reviews the current status of that customer's scheduled service call. First, the customer uses the customer device 112, such as a desktop or laptop computer or a cellphone or other portable device, to connect over the network 104 to the server 102. In reply, the server causes a web page to be displayed by the customer device. The web page typically includes a request that the customer log in, as step 802 shows. For example, the server may cause a login screen to be displayed which has a field into which the customer enters identification information, such as the customer's order number, telephone number, or other information specific to the customer. Alternatively, the server may cause a customer screen 900 having a login field 902, shown in FIG. 9A, to be displayed on a desktop or laptop computer or may cause a customer screen 920 having the login field 902, shown in FIG. 9B, to be displayed by a customer's cellphone or other remote device.

After the server receives the customer's order number, telephone number or other customer specific identification information, as shown in step 804, the server determines whether the order number, telephone number, or other information corresponds to information associated with a scheduled service call, as step 806 shows. When the order number, telephone number, or other identification information is authenticated, the server causes information specific to the customer's service call to be displayed on the customer screen 900 or 920, as step 808 shows, or when a login screen is first used, the customer screen 900 or 920 is now first displayed.

FIG. 9A shows an example of the customer screen 900 that is displayed when the customer uses a desktop computer, a laptop computer, or the like, and FIG. 9B shows an example of the customer screen 920 that is displayed when the customer uses a cellphone or other portable device, each in accordance with the invention. In FIGS. 9A and 9B, the same reference numerals are used to display corresponding fields. For example, the customer screens 900 and 920 each include field 904 showing an icon corresponding to the starting location of the field representative that is to make the service call for that customer and showing icons corresponding to ‘the service locations scheduled for that field representative. An arrival or departure time 906 is displayed either adjacent to, or otherwise identifying, the most recent service call by the field representative. Additionally, icon 908 is displayed adjacent to the icon representing the starting location or adjacent to the icon representing one of the service call locations to indicate that the field representative is currently at that location. Alternatively, icon 908 is located between two such icons to indicate that the field representative is currently in transit between the service locations represented by the two locations. Additionally, or as a further alternative, the shape or color of icon 908 may change according to whether the field representative is currently at a service location or is in transit, or a text legend adjacent to icon 908 provides such description. Also displayed are fields 910, 912, and 914 which correspond to the respective service calls and which present additional information, such as the approximate start time and stop time of each service call and/or which of the displayed service calls is the one scheduled for that customer.

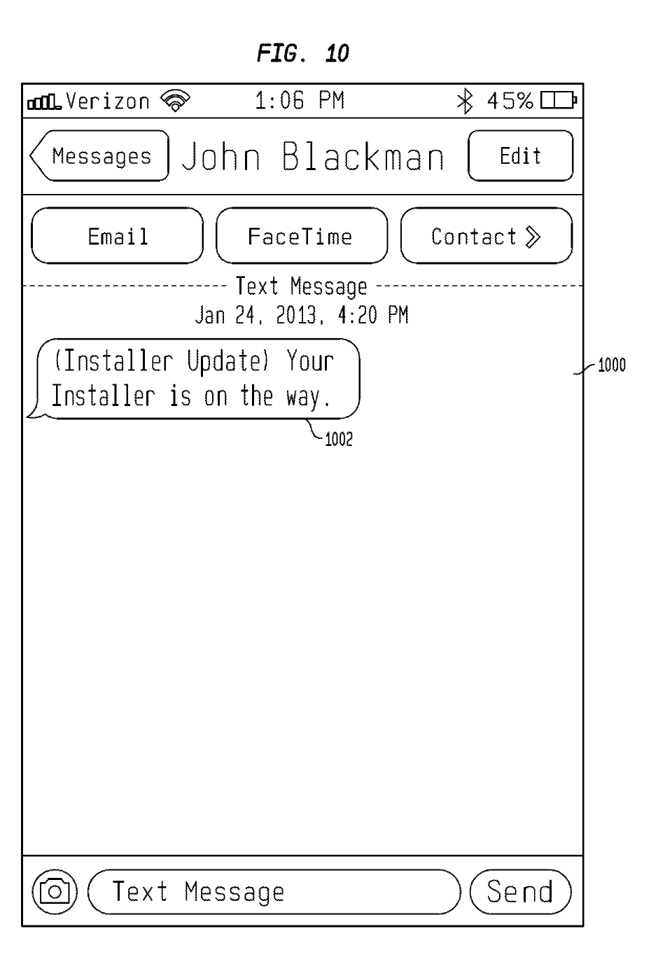

A field 930 may be provided for the customer to enter a cellphone number so that the customer can receive a text message regarding a particular event associated with the customer's service call, such as a text message indicating when the field representative is in transit to the customer's service call location. As shown in step 812 of FIG. 8, the server determines whether a cellphone number has been entered, and when such cellphone number is received, the server causes a text message to be transmitted to that cellphone number at the appropriate time, for example, as shown in FIG. 10. When the server does not receive a customer's cellphone number, the server causes the customer screen to be refreshed at predetermined intervals and/or when the information to be displayed has changed, as described above.

Using the present invention, the movement of field representatives is tracked throughout the day, in essentially real-time. Further, the information displayed on, for example, the dashboard screen or the customer screen, helps an authorized representative or customer to determine whether a field representative is on time to the scheduled service calls.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A host device connected to a network and operable to schedule appointments for a field representative and to track locations of the field representative, the host device comprising:
a processor encoded with instructions for processing and storing new or updated scheduling information provided to the host device regarding appointments to be carried out by the field representative at specified locations, for processing location information about the field representative that is entered into a first remote device each time that the field representative arrives at or departs from one of the specified locations and which is sent over the network to the host device, for updating a current location of the field representative each time that the location information about the field representative is received, and for providing the current location of the field representative and an estimated arrival time of the field representative at a particular one of the specified locations over the network to a second remote device.

2. A host device according to claim 1, wherein the processor is encoded with further instructions for generating and providing, to an admin device connected to the host device, an admin graphical user interface screen into which the appointments to be carried out by the field representative are entered or updated.

3. A host device according to claim 2, wherein the admin graphical user interface includes respective fields into which information identifying the field representative and information relating to each of the appointments are entered or provided.

4. A host device according to claim 1, wherein the processor is encoded with further instructions for generating and providing, over the network to the first remote device, a field representative graphical user interface screen by which the location information about the field representative is updated.

5. A host device according to claim 4, wherein the field representative graphical user interface displays one or more of the specified locations and the scheduled appointments and includes respective fields for providing indications that the field representative has arrived at or departed from one of the specified locations.

6. A host device according to claim 5, wherein the field representative graphical user interface displays one or more check boxes into which the indications that the field representative has arrived at or has departed from one of the specified locations are provided.

7. A host device according to claim 5, wherein the processor is provided with an arrival or departure time each time that one of the indications that the field representative has arrived at or has departed from one of the specified locations is provided.

8. A host device according to claim 4, wherein the processor is encoded with further instructions for generating and providing, over the network to the first remote device, a login screen for providing identification information which is verified prior to the processor providing the field representative graphical user interface.

9. A host device according to claim 1, wherein the processor is encoded with further instructions for generating and providing, over the network to the second remote device, a customer graphical user interface screen which displays information indicating whether the field representative is currently located at one of the specified locations or is in transit between two of the specified locations and the estimated arrival time of the field representative at the specified location of the appointment scheduled for a particular customer.

10. A host device according to claim 9, wherein the customer graphical user interface screen further displays a prior arrival or departure time of the field representative at one or more of the specified locations of appointments scheduled to be earlier than the appointment scheduled for the customer.

11. A host device according to claim 9, wherein the customer graphical user interface screen further displays a field for providing a cell phone number that is to receive a text message indicating that the field representative is in transit to the specified location of the appointment scheduled for the customer.

12. A host device according to claim 9, wherein the processor is encoded with further instructions for generating and providing, over the network to the first remote device, a login screen for providing information identifying at least one of the customer or the appointment scheduled for the customer which is verified prior to the processor providing the customer graphical user interface screen.

13. A host device according to claim 1, wherein the processor is encoded with further instructions for generating and providing, over the network to a third remote device, a dashboard graphical user interface screen which displays information identifying the field representative, identifying each of the appointments or specified locations scheduled for the field representative, and indicating whether the field representative is currently located at one of the appointments or specified locations or is in transit between two of the appointments or specified locations.

14. An appointment scheduler and location tracker system, comprising:
a host device according to claim 1;
a portable device operable as the first remote device; and
a personal computer or portable device operable as the second remote device.

15. A method of scheduling appointments for a field representative and tracking locations of the field representative, the method comprising:
receiving, from an admin terminal, new or updated scheduling information regarding appointments to be carried out by the field representative at specified locations;
storing the new or updated scheduling information;
receiving, from a first remote device over a network, location information about the field representative that is entered into the first remote device each time that the field representative arrives at or departs from one of the specified locations;
updating a current location of the field representative each time that the location information about the field representative is received; and
providing, over the network to a second remote device, the current location of the field representative and an estimated arrival time of the field representative at a particular one of the specified locations.

16. A non-transitory computer-readable medium having recorded therein a computer program for carrying out a method of scheduling appointments for a field representative and tracking locations of the field representative, the method comprising:
receiving, from an admin terminal, new or updated scheduling information regarding appointments to be carried out by the field representative at specified locations;
storing the new or updated scheduling information;
receiving, from a first remote device over a network, location information about the field representative that is entered into the first remote device each time that the field representative arrives at or departs from one of the specified locations;
updating a current location of the field representative each time that the location information about the field representative is received; and
providing, over the network to a second remote device, the current location of the field representative and an estimated arrival time of the field representative at a particular one of the specified locations.
